(19) United States
(12) Patent Application Publication
(10) Pub. No.: US 2025/0104251 A1
(43) Pub. Date: Mar. 27, 2025

(54) Apparatus For Recognizing Object And Method Thereof

(71) Applicants: Hyundai Motor Company, Seoul (KR); Kia Corporation, Seoul (KR)

(72) Inventor: En Sun Lee, Seoul (KR)

(21) Appl. No.: 18/629,017

(22) Filed: Apr. 8, 2024

(30) Foreign Application Priority Data
Sep. 25, 2023 (KR) 10-2023-0128422

(51) Int. Cl. G06T 7/20; G06T 7/70; G06V 10/25

(52) U.S. Cl. CPC G06T 7/20; G06T 7/70; G06V 10/25; G06V 2201/07

(57) ABSTRACT

The present disclosure relates to an object recognition apparatus and method. The object recognition apparatus includes a sensor (e.g., a LIDAR) and a processor. The processor may determine, via the sensor, an object in a first frame, determine a first moving direction of the object in the first frame, determine a reliability value of the first moving direction, determine a point representing the object in the first frame based on a representative moving direction of the object, and output a signal indicating whether the object is a moving object or a movable stationary object.

### CROSS-REFERENCE TO RELATED APPLICATION

This application claims the benefit of priority to Korean Patent Application No. 10-2023-0128422, filed in the Korean Intellectual Property Office on Sep. 25, 2023, the entire contents of which are incorporated herein by reference.

### TECHNICAL FIELD

The present disclosure relates to an object recognition apparatus and method, and more particularly, to a technique for identifying characteristics of an object based on contour point obtained through a light detection and ranging (LIDAR).

### BACKGROUND

Technology for detecting surrounding environments and distinguishing between obstacles is required for an autonomous vehicle or a vehicle with activated driver assistance devices to adjust its driving path and avoid obstacles with minimal driver intervention.

A vehicle may obtain data indicating the position of an object around the vehicle through a LIDAR. A distance from a LIDAR to an object can be obtained through an interval between the time when laser is transmitted by the LIDAR and the time when the laser reflected by the object is received. A vehicle may identify the location of a point included outside of the object in a space where the vehicle is located, based on the angle of the transmitted laser and the distance to the object.

Based on the movement information of acquired points from the LIDAR, the autonomous vehicle or the vehicle with an activated driver assistance device may identify information of an object represented by the points. In particular, technology to identify whether an object is a moving object, an object capable of being in a moving state, or an object incapable of being in a moving state may be essential to ensure the stability of autonomous driving or driver assistance driving and reduce the risk of accidents.

### SUMMARY

The present disclosure has been made to solve the above-mentioned problems occurring in at least some implementations while advantages achieved by those implementations are maintained intact.

An aspect of the present disclosure provides an object recognition apparatus and method for identifying whether an object is a moving object or an object capable of being in a moving state by selecting one representative point among a point cloud.

An aspect of the present disclosure provides an object recognition apparatus and method for improving the accuracy of determination of identifying whether an object is a moving object or an object capable of being in a moving state by selecting one representative point among a point cloud based on the moving direction of the object having a reliability value greater than a specified reliability value.

An aspect of the present disclosure provides an object recognition apparatus and method for improving the accuracy of determination of identifying whether an object is a moving object or an object capable of being in a moving state by selecting one representative point among a point cloud based on identifying whether the object satisfies a specified condition.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an object recognition apparatus may include: a sensor associated with a vehicle; and a processor. The processor may be configured to: determine, via the sensor, an object in a first frame; determine a first moving direction of the object in the first frame; determine a reliability value of the first moving direction; and determine a point representing the object in the first frame based on a representative moving direction of the object. The representative moving direction may be one of: the first moving direction based on the reliability value being greater than a threshold value, or a second moving direction of the object in a second frame preceding the first frame based on the reliability value being less than or equal to the threshold value. The processor may be further configured to output, based on a first position of the point in the first frame and a second position of the point in at least one frame before the first frame, a signal indicating whether the object is a moving object or a movable stationary object.

The processor may be configured to determine the point by: determining an object box representing the object in the first frame; determining, based on the representative moving direction, a line segment associated with the object box; and determining the point further based on the line segment.

The processor may be configured to determine the point by: determining an object box representing the object in the first frame; determining, based on a third position of the object in the first frame and a fourth position of the object in the at least one frame before the first frame, a first heading of the object box in the first frame; determining, based on the first heading and a second heading of the object box in the at least one frame before the first frame, a track heading of the object box in the first frame; determining a line segment associated with the object box based on the first heading being within a first range, the track heading being within a second range, and the representative moving direction being a specified direction; and determining the point further based on the line segment.

The processor may be configured to determine the point by: determining an object box representing the object in the first frame; assigning a different index, of a plurality of indices, to each of a plurality of vertices forming the object box; and determining the point, further based on the plurality of indices.

The processor may be configured to determine the point by: determining an object box representing the object in the first frame; determining, based on the first position of the object in the first frame, and the second position of the object in the at least one frame before the first frame, a first heading of the object box; determining, based on the first heading and a second heading of the object box in the at least one frame before the first frame, a track heading of the object box in the first frame; assigning a different index, of a plurality of indices, to each of a plurality of vertices forming the object box, based on the first heading being within a first range, the track heading being within a second range, and the representative moving direction being a specified direction; and determining the point further based on the plurality of indices.

The processor may be configured to determine the point by: determining an object box representing the object in the first frame; and determining the point based on one of: a first line segment having, among line segments associated with the object box, a smallest longitudinal distance to the vehicle, based on the representative moving direction being parallel to a longitudinal axis of the vehicle, or a second line segment having, among the line segments associated with the object box, a smallest lateral distance to the vehicle, based on the representative moving direction being perpendicular to the longitudinal axis of the vehicle.

The processor may be configured to determine the point by: determining an object box representing the object in the first frame; and determining the point based on a center point of one line segment among line segments constituting the object box.

The processor may be configured to determine the first moving direction of the object in the first frame based on a value obtained by adding a first distance moved by the vehicle to a second distance moved by the object with respect to the vehicle. The second distance may be determined based on a difference between the first position and the second position.

The processor may be configured to determine whether the object is a moving object or a movable stationary object further based on a speed of the object. The speed of the object may be determined based on the first position and the second position.

The processor may be further configured to assign, to the object, one of: a first identifier indicating that the object is a moving object, or a second identifier indicating that the object is a movable stationary object.

According to one or more example embodiments of the present disclosure, a method may include: determining, via a sensor associated with a vehicle, an object in a first frame; determining a first moving direction of the object in the first frame; determining a reliability value of the first moving direction; and determining a point representing the object in the first frame based on a representative moving direction of the object. The representative moving direction may be one of: the first moving direction based on the reliability value being greater than a threshold value, or a second moving direction of the object in a second frame preceding the first frame based on the reliability value being less than or equal to the threshold value. The method may further include outputting, based on a first position of the point in the first frame and a second position of the point in at least one frame before the first frame, a signal indicating whether the object is a moving object or a movable stationary object.

Determining the point may include: determining an object box representing the object in the first frame; determining, based on the representative moving direction, a line segment associated with the object box; and determining the point further based on the line segment.

Determining the point may include: determining an object box representing the object in the first frame; determining, based on a third position of the object in the first frame and a fourth position of the object in the at least one frame before the first frame, a first heading of the object box in the first frame; determining, based on the first heading and a second heading of the object box in the at least one frame before the first frame, a track heading of the object box in the first frame; determining a line segment associated with the object box based on the first heading being within a first range, the track heading being within a second range, and the representative moving direction being a specified direction; and determining the point further based on the line segment.

Determining the point may include: determining an object box representing the object in the first frame; assigning a different index, of a plurality of indices, to each of a plurality of vertices forming the object box; and determining the point, further based on the plurality of indices.

Determining the point may include: determining an object box representing the object in the first frame; determining, based on the first position of the object in the first frame, and the second position of the object in the at least one frame before the first frame, a first heading of the object box; determining, based on the first heading and a second heading of the object box in the at least one frame before the first frame, a track heading of the object box in the first frame; assigning a different index, of a plurality of indices, to each of a plurality of vertices forming the object box, based on the first heading being within a first range, the track heading being within a second range, and the representative moving direction being a specified direction; and determining the point further based on the plurality of indices.

Determining the point may include: determining an object box representing the object in the first frame; and determining the point based on one of: a first line segment having, among line segments associated with the object box, a smallest longitudinal distance to the vehicle, based on the representative moving direction being parallel to a longitudinal axis of the vehicle, or a second line segment having, among the line segments associated with the object box, a smallest lateral distance to the vehicle, based on the representative moving direction being perpendicular to the longitudinal axis of the vehicle.

Determining the point may include: determining an object box representing the object in the first frame; and determining the point based on a center point of one line segment among line segments constituting the object box.

Determining the first moving direction of the object in the first frame may include determining the first moving direction of the object in the first frame based on a value obtained by adding a first distance moved by the vehicle to a second distance moved by the object with respect to the vehicle. The second distance may be determined based on a difference between the first position and the second position.

The object recognition method may further include: determining whether the object is a moving object or a movable stationary object further based on a speed of the object. The speed of the object may be determined based on the first position and the second position.

The object recognition method may further include: assigning, to the object, one of: a first identifier indicating that the object is a moving object, or a second identifier indicating that the object is a movable stationary object.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing an object recognition apparatus according to an embodiment of the present disclosure;

FIG. 2 is a table showing information required to classify objects in an object recognition apparatus or an object recognition method according to an embodiment of the present disclosure;

FIG. 3 shows an area in which the weights of features values vary according to information related to an object recognition apparatus or an object recognition method according to an embodiment of the present disclosure;

FIG. 4 shows examples of a representative point identified according to the moving direction of an object in an object recognition apparatus or an object recognition method according to an embodiment of the present disclosure;

FIG. 5 shows a flowchart of operation of an object recognition apparatus for identifying whether an object is a moving object or an object capable of being in a moving state based on a representative point according to the moving direction of an object in an object recognition apparatus or an object recognition method according to an embodiment of the present disclosure;

FIG. 6 shows an example of a representative moving direction identified according to a reliability in an object recognition apparatus or an object recognition method according to an embodiment of the present disclosure;

FIG. 7 shows an example of a representative point identified based on a heading in a first reference range, a track heading, and a representative moving direction in an object recognition apparatus or an object recognition method according to an embodiment of the present disclosure;

FIG. 8 shows an example of a representative point identified based on a heading in a second reference range, a track heading, and a representative moving direction in an object recognition apparatus or an object recognition method according to an embodiment of the present disclosure;

FIG. 9 shows an example of a representative point identified according to a representative moving direction in an object recognition apparatus or an object recognition method according to an embodiment of the present disclosure;

FIG. 10 shows examples of representative points provided according to an existing object recognition apparatus or an object recognition method and an example of representative points provided according to an object recognition apparatus or an object recognition method according to an embodiment of the present disclosure;

FIG. 11 shows an example of a path of an object, which is identified based on an existing object recognition apparatus or an object recognition method and a path of an object, which is identified based on an object recognition apparatus or an object recognition method according to an embodiment of the present disclosure;

FIG. 12 shows an example of a path of an object identified based on an existing object recognition apparatus or an object recognition method and an example of a path of an object identified based on an object recognition apparatus or an object recognition method according to an embodiment of the present disclosure;

FIG. 13 shows an example of a path of an object, which is identified based on an existing object recognition apparatus or an object recognition method and a path of an object, which is identified based on an object recognition apparatus or an object recognition method according to an embodiment of the present disclosure; and

FIG. 14 shows a computing system related to an object recognition apparatus and an object recognition method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Further, the terms “unit”, “device”, “member”, “body”, or the like used hereinafter may indicate at least one shape structure or may indicate a unit for processing a function.

In addition, in embodiments of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

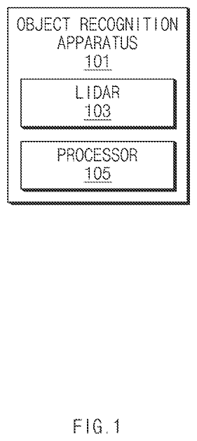

Hereinafter, embodiments of the present disclosure will be described in detail with reference to FIGS. 1 to 13.

FIG. 1 is a block diagram showing an object recognition apparatus according to an embodiment of the present disclosure.

Referring to FIG. 1, an object recognition apparatus 101 according to an embodiment of the present disclosure may be implemented inside a vehicle. In this case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a sensor, such as a LIDAR 103, and a processor 105.

According to an embodiment, the processor 105 of the object recognition apparatus 101 may acquire a point cloud representing the object through the sensor (e.g., the LIDAR 103).

According to an embodiment, the processor 105 of the object recognition apparatus 101 may identify an object in a first frame based on a point cloud included in a specific first frame. The processor 105 of the object recognition apparatus 101 may identify (e.g., estimate) a first moving direction indicating the direction of movement of an object in the first frame and reliability (e.g., a reliability value, a reliability score, a confidence value, an accuracy rating, etc.) of the first moving direction. A frame may be a collection of points (e.g., data points) collected by the sensor (e.g., the LIDAR 103) at a single time or in a single duration of time. The sensor (e.g., the LIDAR 103) may collect data (e.g., points) in one or more frames over time to track any presence or movements of objects around the host vehicle.

When the reliability of estimation of the first moving direction is greater than a specific reliability value, the processor of the object recognition apparatus may identify the first moving direction as a representative moving direction. The processor 105 of the object recognition apparatus 101 may identify a representative point representing an object in the first frame based on the first moving direction.

When the reliability of estimation of the first moving direction is less than or equal to a specific reliability value, the processor 105 of the object recognition apparatus 101 may identify a second direction indicating the direction of movement of the object in a second frame immediately before (e.g., preceding) the first frame as a representative moving direction. The representative moving direction in the first frame may include the second moving direction. The processor 105 of the object recognition apparatus 101 may identify a representative point representing an object in the first frame based on the second moving direction.

The processor 105 of the object recognition apparatus 101 may identify whether an object is a moving object or a stationary object that is capable of being in a moving state (also referred to as a movable stationary object) based on the position of a representative point representing the object in the first frame, and the position of a representative point representing the object in at least one frame before the first frame.

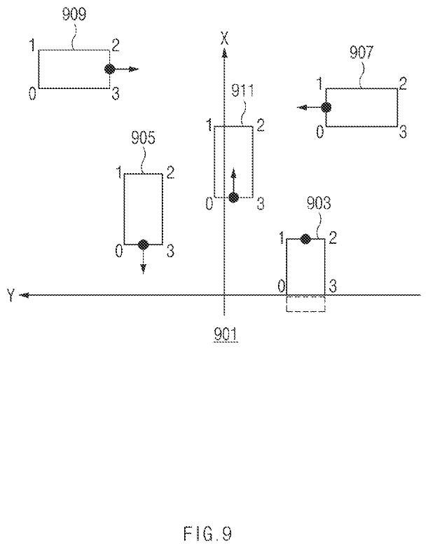

According to an embodiment, the processor 105 of the object recognition apparatus 101 may assign an index to each of a plurality of vertices forming an object box, and identify one of line segments constituting the object box based on the indexes of the plurality of vertices and the representative moving direction. The processor 105 of the object recognition apparatus 101 may identify a representative point representing an object based on one line segment. A method of identifying a representative point based on the representative moving direction will be described below with reference to FIG. 9.

However, when a heading is included in a reference range, a track heading is included in a specified range, and a representative moving direction is a specified direction, the processor 105 of the object recognition apparatus 101 may identify a representative point representing an object based on the heading, the track heading, and the representative moving direction.

In other words, the processor 105 of the object recognition apparatus 101 may identify the heading of an object box based on the position of the object in the first frame and the position of the object in at least one frame before the first frame. The processor 105 of the object recognition apparatus 101 may identify the track heading of the object box in the first frame based on the heading and the heading of the object box in at least one frame before the first frame. The processor 105 of the object recognition apparatus 101 may assign an index to each of the plurality of vertices that form the vertices of the object box based on the heading being within the reference range, the track heading being within the specified range, and the representative moving direction being the specified direction, identify one of line segments constituting the object box based on the indices of the plurality of vertices and the representative moving direction, and identify a representative point representing an object based on the one line segment.

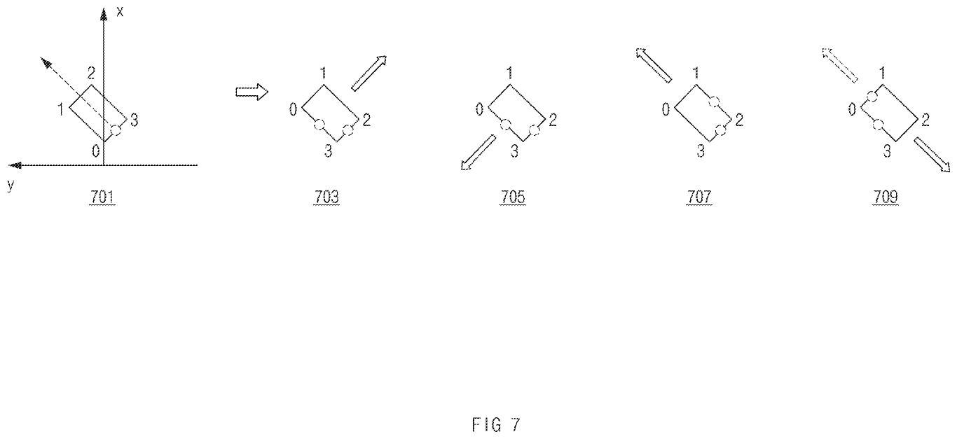

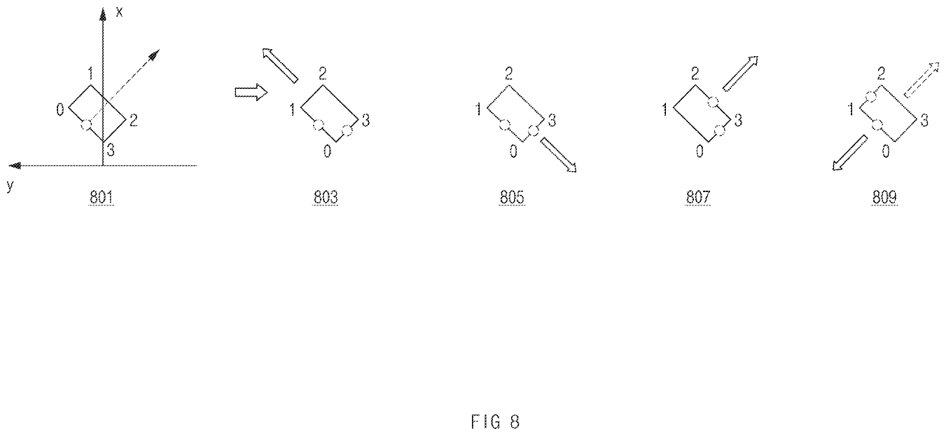

A method of identifying a representative point based on the heading, the representative moving direction, and the track heading will be described below with reference to FIGS. 7 and 8.

According to one embodiment, an object box may include a virtual box to which information related to an external object is assigned. For example, the object box may be referred to as a contour box. According to one embodiment, the contour box may be created (or formed) based on contour points. For example, the contour box may correspond to an external object. For example, the contour box may include the virtual box to which the information related to the external object is assigned. For example, the information related to the external object may include at least one of the type of the external object, the speed of the external object, the moving direction of the external object, or the position of the external object, or any combination thereof.

According to an embodiment, the heading may indicate the moving direction of an external object included in an object box. The track heading may be identified based on the heading of an object box included in a previous frame. For example, the track heading of a specific frame may be identified based on at least one heading of an object box included in at least one frame before the specific frame.

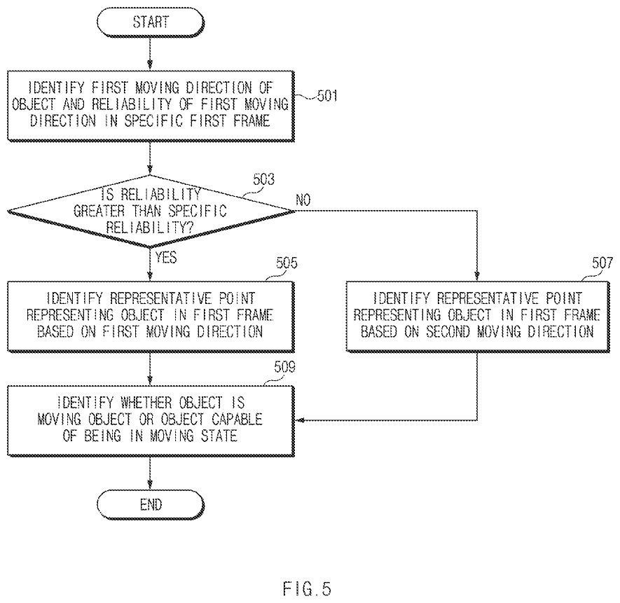

According to an embodiment, the processor 105 of the object recognition apparatus 101 may identify a feature value according to tracking information. The operation of the object recognition apparatus, which identifies a feature value according to tracking information based on an identified representative point will be described below with reference to FIG. 5.

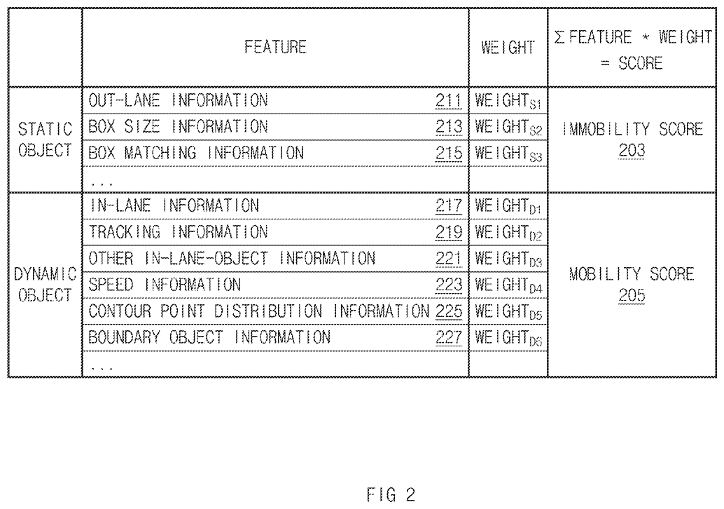

According to an embodiment, the processor 105 of the object recognition apparatus 101 may calculate a score value indicating a probability that an object is a moving object (e.g. a moving vehicle) or a stationary object that is movable (e.g. a stationary vehicle), based on a feature value according to tracking information of the object. The identifying of a score value indicating a probability that an object is a moving object or a movable stationary object based on the feature value according to the tracking information will be described below with reference to FIG. 2.

According to an embodiment, the processor 105 of the object recognition apparatus 101 may identify that an object is a moving object or a movable stationary object, based on a score value indicating the probability that an object is a moving object (e.g., a moving vehicle) or a movable stationary object (e.g., a stationary vehicle) being greater than a score value indicating the probability that an object is a stationary object that is incapable of being in a moving state (also referred to as an unmovable stationary object), such as the pole with a traffic sign.

According to an embodiment, the processor 105 of the object recognition apparatus 101 may assign, to the object, an identifier indicating that the object is a moving object or a movable stationary object based on identifying that the object is a moving object or a movable stationary object. The identifier may be referred to as a flag, but may not be limited thereto.

FIG. 2 is a table showing information required to classify objects in an object recognition apparatus or an object recognition method according to an embodiment of the present disclosure.

Referring to FIG. 2, table 201 may represent types of information for calculating a score for identifying whether an object is a moving object or a movable stationary object. An immobility score 203 may represent a score for identifying whether an object is an unmovable stationary object. The immobility score 203 may be identified based on information such as out-lane information 211, box size information 213, and box matching information 215. A mobility score 205 may represent a score for identifying whether an object is a moving object or a movable stationary object. The mobility score 205 may be identified based on information such as in-lane information 217, tracking information 219, other in-lane-object information 221, speed information 223, contour point distribution information 225, and boundary object information 227.

According to an embodiment, a first feature value may be a feature for determining whether an object is an unmovable stationary object. The processor of the object recognition apparatus may identify the immobility score 203 by the sum of values obtained by multiplying first feature values indicated by pieces of information by a weight. A second feature value may be a feature for determining whether an object is a moving object or a movable stationary object. The processor of the object recognition apparatus may identify the mobility score 205 by the sum of values obtained by multiplying second feature values indicated by pieces of information by a weight.

According to an embodiment, the out-lane information 211 for identifying the immobility score 203 may represent a first feature value assigned based on whether an object is identified outside a lane. The box size information 213 for identifying the immobility score 203 may represent a first feature value assigned based on whether the size of an object box is greater than or equal to a reference size. The box matching information 215 for identifying the immobility score 203 may represent a feature value assigned based on the distribution of contour points and the degree of match of the object box.

According to an embodiment, contour points may be obtained by the sensor (e.g., a LiDAR). For example, the contour points may be identified in each of layers formed based on the z-axis, among the x-axis, y-axis, and z-axis. For example, the contour points may be obtained based on outer points included in a point cloud in each of the layers formed on the z-axis among the x-axis, y-axis, and z-axis. For example, the outer points may include all or part of points located outside among a plurality of points included in the point cloud. For example, a point cloud may be obtained by performing clustering based on each of a plurality of points acquired by a sensor (e.g., a LIDAR) being identified within a specified distance.

According to an embodiment, the in-lane information 217 may represent a second feature value assigned based on whether an object is identified inside a lane. The tracking information 219 may represent a second feature value assigned based on whether an object is moving. The speed information 223 may represent a second feature value assigned based on the speed of an object. The boundary object information 227 may represent the second feature value assigned based on whether an object is viewed without being obscured at the boundary of a field of view.

According to an embodiment, the immobility score 203 may be identified by the sum of values obtained by multiplying the first feature value represented by pieces of information by a weight. For example, the immobility score 203 may be identified by the sum of a value obtained by multiplying the first feature value according to the out-lane information 211 by a weight (e.g., weight_{S1}) corresponding to the out-lane information 211, a value obtained by multiplying the first feature value according to the box size information 213 by a weight (e.g., weight_{S2}) corresponding to the box size information 213, a value obtained by multiplying the first feature value according to the box matching information 215 by a weight (e.g., weight_{S3}) corresponding to the box matching information 215, or at least one of any combination thereof. However, embodiments of the present disclosure may not be limited thereto. According to an embodiment, the immobility score 203 may be identified by adding up not only a value obtained by multiplying information listed in the table 201 by a weight, but also a value obtained by multiplying information not listed in the table 201 by the weight.

According to an embodiment, the mobility score 205 may be identified by the sum of values obtained by multiplying the second feature values represented by pieces of information by a weight. For example, the mobility score 205 may be identified by the sum of at least one of a value obtained by multiplying the second feature value according to the in-lane information 217 by a weight (e.g., weight_{D1}) corresponding to the in-lane information 217, a value obtained by multiplying the second feature value according to the tracking information 219 by a weight (e.g., weight_{D2}) corresponding to the tracking information 219, a value obtained by multiplying the second feature value according to the other in-lane-object information 221 by a weight (e.g., weight_{D3}) corresponding to the other in-lane-object information 221, a value obtained by multiplying the second feature value according to the speed information 223 by a weight (e.g., weight_{D4}) corresponding to the speed information 223, a value obtained by multiplying the second feature value according to the contour point distribution information 225 by a weight (e.g., weight_{D5}) corresponding to the contour point distribution information 225, a value obtained by multiplying the second feature value according to the boundary object information 227 by a weight (e.g., weight_{D6}) corresponding to the boundary object information 227, or any combination thereof. However, embodiments of the present disclosure may not be limited thereto. According to an embodiment, the mobility score 205 may be identified by adding up not only a value obtained by multiplying information listed in the table 201 by a weight, but also a value obtained by multiplying information not listed in the table 201 by the weight.

According to an embodiment, when the mobility score 205 for a certain object is higher than the immobility score 203 for the certain object, the processor of the object recognition apparatus may identify that the certain object is a moving object or a movable stationary object. According to an embodiment, when the immobility score 203 for a certain object is higher than the mobility score 205 for the certain object, the processor of the object recognition apparatus may identify that the certain object is an unmovable stationary object.

According to an embodiment of the present disclosure, the processor of the object recognition apparatus may identify the second feature value indicated by the tracking information 219. A method for identifying the second feature value indicated by the tracking information 219 according to an embodiment is described below in FIG. 5.

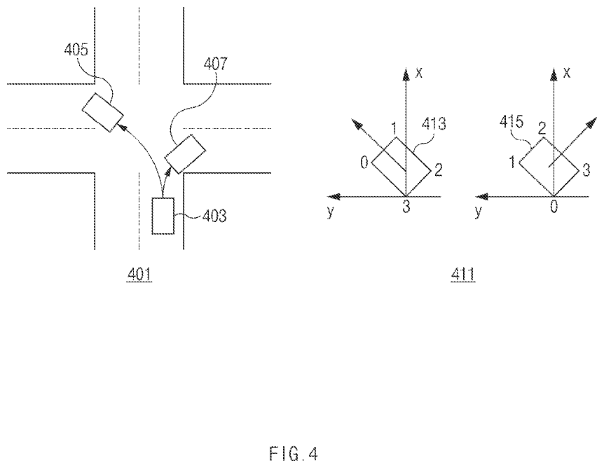

According to an embodiment of the present disclosure, the processor of the object recognition apparatus may identify a representative point for obtaining the tracking information 219. A method for identifying representative points according to an embodiment will be described below with reference to FIGS. 4 to 9.

Hereinafter, the second feature value indicated by the tracking information 219 may be referred to as a feature value.

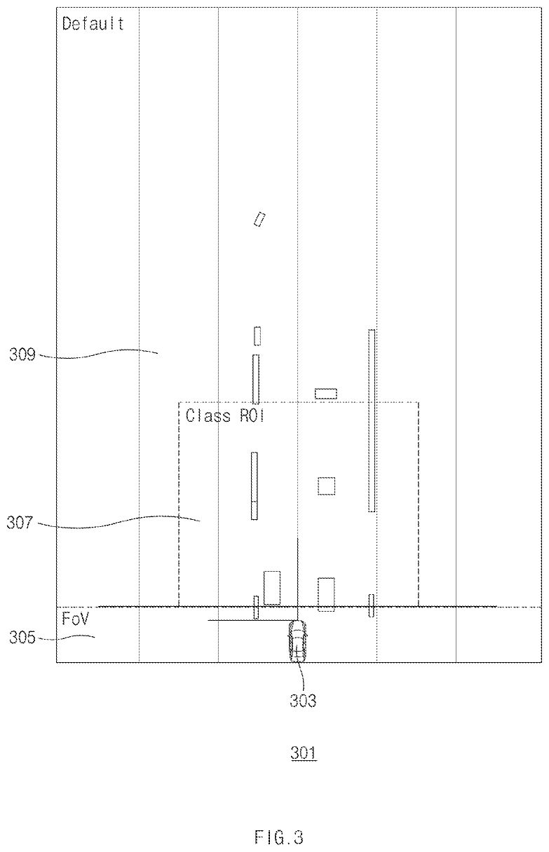

FIG. 3 shows an area in which the weights of features values vary according to information related to an object recognition apparatus or an object recognition method according to an embodiment of the present disclosure.

Referring to FIG. 3, a frame 301 may represent a first area 305, a second area 307, and a third area 309 separated according to a distance from a host vehicle 303 including the object recognition apparatus. The first area 305 may include an area within a field of view. The second area 307 may include an area for classifying objects of interest. The third area 309 may include areas other than the first area 305 and the second area 307.

According to an embodiment, the first area 305 may be referred to as a field of view (FoV) area, but may not be limited thereto. The second area 307 may be referred to as a class region of interest (class ROI), but may not be limited thereto. The third area 309 may be referred to as a default region, but may not be limited thereto.

According to an embodiment, the processor of the object recognition apparatus may assign different weights (e.g., weights in FIG. 2) for identifying an immobility score or a mobility score according to an area in which an object is included. This is because information of high importance may be changed depending on the position of an object. For example, the processor of the object recognition apparatus may set a weight of contour point distribution information (e.g., the contour point distribution information 225 in FIG. 2) to a value greater than 0 only in the second area 307. For example, the processor of the object recognition apparatus may set a weight of boundary object information (e.g., the boundary object information 227 in FIG. 2) in the first area 305 greater than a weight of the boundary object information in the second area 307 and a weight of the boundary object information in the third area 309.

FIG. 4 shows examples of a representative point identified according to the moving direction of an object in an object recognition apparatus or an object recognition method according to an embodiment of the present disclosure.

Referring to FIG. 4, in a first situation 401, the moving direction of an object at a first position 403 is changed to the moving direction of the object at a second position 405, or the moving direction of the object at a third position 407.

In a second situation 411, the moving direction of a first object 413 may be different from the moving direction of a second object 415.

According to an embodiment, the processor of an object recognition apparatus included in a host vehicle may acquire a point cloud through a sensor (e.g., a LIDAR). The processor of the object recognition apparatus may identify the position of an object based on the acquired point cloud. For example, the object may be located at the first position 403, the second position 405, or the third position 407.

According to an embodiment, an object located at the first position 403 may move to the second position 405. Accordingly, as the moving direction of the object located at the first position 403 changes to the second position 405, the representative point for identifying a feature value according to the tracking information of the object may change.

An object located at the first position 403 may move to the third position 407. Accordingly, as the moving direction of the object located at the first position 403 changes to the third position 407, the representative point for identifying a feature value according to the tracking information of the object may change.

Unlike an existing object recognition apparatus, the object recognition apparatus according to an embodiment may continuously select a specific point of an object box as a representative point even when the moving direction of the object changes.

In a second situation 411, the processor of the object recognition apparatus may assign an index to each of a plurality of vertices forming the vertices of the object box representing an object (e.g., the first object 413 or the second object 415) and identify a representative point representing the object based on the indices of the plurality of vertices and the moving direction of the object.

In the second situation 411, the moving direction of the first object 413 may be approximately 45 degrees from the (+x)-axis direction. The moving direction of the second object 415 may be approximately-45 degrees from the (+x)-axis direction.

When the moving direction of the first object 413 is less than about 45 degrees from the (+x)-axis direction, the indices (3, 0, 1, and 2) assigned to the vertices of the object box representing the first object 413 may be different from the indices (0, 1, 2, and 3) assigned to the vertices of the object box representing the first object 413 when the moving direction of the first object 413 is about 45 degrees or more from the (+x)-axis direction.

Therefore, an existing object recognition apparatus may identify the representative point of the first object 413, which is determined according to the indexes respectively assigned to the vertices of the object box and the moving direction, as a discontinuous point according to the movement of the first object 413.

The object recognition apparatus according to an embodiment may identify the representative points of the first object 413 as a continuous point according to the moving direction of the first object 413.

When the moving direction of the second object 415 is less than about −45 degrees from the (+x)-axis direction, the indices (0, 1, 2, 3) assigned to the vertices of the object box representing the second object 415 may be different from the indices (3, 0, 1, 2) assigned to the vertices of the object box representing the second object 415 when the moving direction of the second object 415 is about −45 degrees or more from the (+x)-axis direction.

Therefore, an existing object recognition apparatus may identify the representative point of the second object 415, which is determined according to the indexes respectively assigned to the vertices of the object box and the moving direction, as a discontinuous point according to the movement of the second object 415.

The object recognition apparatus according to an embodiment may identify the representative point of the second object 415 as being a continuous point according to the movement of the second object 415.

FIG. 5 shows a flowchart of operation of an object recognition apparatus for identifying whether an object is a moving object or a movable stationary object based on a representative point according to the moving direction of an object in an object recognition apparatus or an object recognition method according to an embodiment of the present disclosure.

Hereinafter, it is assumed that the object recognition apparatus 101 of FIG. 1 performs the process of FIG. 5. Additionally, in the description of FIG. 5, operations described as being performed by the apparatus may be understood as being controlled by the processor 105 of the object recognition apparatus 101.

Referring to FIG. 5, in a first operation 501, the processor of the object recognition apparatus according to an embodiment may identify a first moving direction of an object and reliability (e.g., a reliability) of the first moving direction in a specific first frame.

According to an embodiment, the moving direction of the object may be identified based on a road on which the object and a host vehicle are located. For example, the processor of the object recognition apparatus may identify the moving distance of the object in the first frame based on the sum of a movement distance of the object with respect to the host vehicle and a movement distance of the host vehicle according to a difference between the position of the object in the first frame and the position of the object in at least one frame before the first frame.

According to an embodiment, one of 1 point, 2 points, and 3 points may be given as a reliability of the moving direction of the object.

In a second operation 503, the processor of the object recognition apparatus according to an embodiment may identify whether the reliability is greater than a specific reliability value. When the reliability is greater than the specific reliability value, the processor of the object recognition apparatus may perform a third operation 505. When the reliability is not greater than the specific reliability value, the processor of the object recognition apparatus may perform a fourth operation 507.

The reason for this is to identify the moving direction of the object with the reliability greater than the specific reliability value as a representative moving direction. The moving direction of the object may differ from the actual moving direction of the object due to errors caused by the operation of the host vehicle.

In a third operation 505, the processor of the object recognition apparatus according to an embodiment may identify a representative point representing the object in the first frame based on a first moving direction.

According to an embodiment, the processor of the object recognition apparatus may identify the first moving direction as the representative moving direction, and identify a representative point representing the object in the first frame based on the first moving direction, which is the representative moving direction.

In a fourth operation 507, the processor of the object recognition apparatus according to an embodiment may identify the representative point representing the object in the first frame based on a second moving direction.

According to an embodiment, the second moving direction may indicate the moving direction of the object in a second frame immediately before (e.g., preceding) the first frame. According to an embodiment, the processor of the object recognition apparatus may identify the second moving direction as the representative moving direction, and identify a representative point representing the object in the first frame based on the second moving direction, which is the representative moving direction.

In a fifth operation 509, the processor of the object recognition apparatus may identify whether the object is a moving object or a movable stationary object. The processor of the object recognition apparatus may output a signal indicating whether the object is a moving object or a movable stationary object, for example, to allow a vehicle to identify the object and react (e.g., avoid the object) accordingly by controlling the vehicle.

According to an embodiment, the processor of the object recognition apparatus may identify whether an object is a moving object or a movable stationary object based on the speed of the object identified according to the position of a representative point representing the object in the first frame and the position of a representative point representing the object in at least one frame before the first frame.

According to an embodiment, the processor of the object recognition apparatus may assign, to the object, an identifier indicating that the object is a moving object or a movable stationary object based on identifying that the object is a moving object or a movable stationary object.

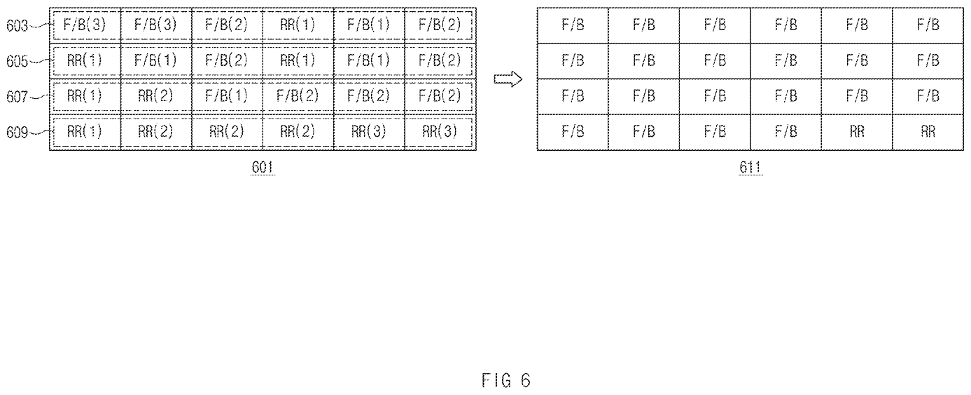

FIG. 6 shows an example of a representative moving direction identified according to features in an object recognition apparatus or an object recognition method according to an embodiment of the present disclosure.

Referring to FIG. 6, a first table 601 may indicate the moving direction of an object and a reliability of the moving direction. A second table 611 may indicate the representative moving direction of the object. A first row 603 may indicate the moving direction and reliability of an object included in a frame after a first time point and before a second time point. A second row 605 may indicate the moving direction and reliability of an object included in a frame after the second time point and before a third time point. A third row 607 may indicate the moving direction and reliability of an object included in a frame after the third time point and before a fourth time point. A fourth row 609 may indicate the moving direction and reliability of an object included in a frame after the fourth time point and before a fifth time point.

According to an embodiment, the processor of the object recognition apparatus may identify the moving direction of the object in the first frame based on a difference between the position of the object in the first frame and the position of the object in at least one frame before the first frame. An F/B direction may refer to a direction opposite to the moving direction of a host vehicle. An RR direction may refer to the right direction with respect to the moving direction of the host vehicle.

According to an embodiment, in a frame corresponding to RR(1) in the first row 603, a moving direction is identified as the RR direction to the right of the moving direction of the host vehicle, but the reliability of the moving direction of the object may be 1.

The processor of the object recognition apparatus may identify a reliability value greater than a specific reliability value as a representative moving direction. Because the object corresponding to the RR(1) has the reliability of the moving direction of the object not exceeding a specific reliability value (e.g., about 2) when the specific reliability value is 2, the F/B direction which is the moving direction of the object in a previous frame, may be identified as the representative moving direction of the object.

According to an embodiment, in the frame corresponding to RR(3) in the fourth row 609, the moving direction may be identified as the RR direction to the right of the moving direction of the host vehicle, and the reliability of the moving direction of the object may be 3.

According to an embodiment, because the reliability of the moving direction of the object corresponding to RR(3) is greater than the specific reliability value (e.g., about 2) when the specific reliability value is 2, the RR direction, which is the moving direction in a relevant frame, not the moving direction of the object in the previous frame may be identified as the representative moving direction of the object.

FIG. 7 shows an example of a representative point identified based on a heading, a track heading, and a representative moving direction in an object recognition apparatus or an object recognition method according to an embodiment of the present disclosure.

Referring to FIG. 7, the heading of the object box of an object 701 may be included within a first reference range. A first situation 703, a second situation 705, a third situation 707, and a fourth situation 709 may represent an object whose track heading is included within a specified range and whose moving direction is a specified direction.

According to an embodiment, the heading of the object box of the object 701 may be included in the range of a value obtained by adding or subtracting a specified value to or from +45 degrees in the (+x)-axis direction. For example, the heading of the object box of object 701 may be included in a range of more than or equal to about 43 degrees and less than about 47 degrees in the (+x)-axis direction, but embodiments of the present disclosure may not be limited thereto.

According to an embodiment, when the representative moving direction of the object 701 is an F/B direction opposite to the moving direction of the host vehicle, the representative point may correspond to the center point of the line segment of the object box assigned indexes of 0 and 3.

According to an embodiment, when the heading of the object is included in a first reference range, the processor of the object recognition apparatus may identify a representative point differently from the representative point identified according to a representative moving direction and an index before the change in four situations. The four situations may include the first situation 703, the second situation 705, the third situation 707, and the fourth situation 709.

According to an embodiment, the processor of the object recognition apparatus may identify the track heading of an object box in a first frame based on the heading of the first frame and the heading of the object box in at least one frame before the first frame. For example, when the heading of the object box was about −45 degrees from the (+x)-axis direction in two or more frames before the first frame, the track heading of the object box may be about −45 degrees.

According to an embodiment, in the first situation 703, the heading of the object box of the object may be included in a range of a value obtained by adding or subtracting a specified value to or from about +45 degrees in the (+x)-axis direction (e.g., more than or equal to about 43 degrees and less than about 47 degrees).

The processor of the object recognition apparatus may re-identify the index corresponding to the object box when the track heading of the object box is included within a specified range (e.g., a range between about −43 degrees and about −47 degrees from the (+x)-axis direction), and the representative moving direction corresponds to the specified direction (e.g., the F/F direction identical to the moving direction of the host vehicle). Further, the processor of the object recognition apparatus may identify, as the representative point, the center point between the vertex with an index of 0 after the change and the vertex with an index of 3 after the change, rather than the center point between the vertex with an index of 0 before the change (e.g., the vertex with an index of 3 after the change) and the vertex with an index of 3 before the change (e.g., the vertex with an index of 2 after the change).

According to an embodiment, in the second situation 705, the heading of the object box of the object may be included in a range of a value obtained by adding or subtracting a specified value to or from about +45 degrees in the (+x)-axis direction (e.g., more than or equal to about 43 degrees and less than about 47 degrees).

The processor of the object recognition apparatus may re-identify the index corresponding to the object box when the track heading of the object box is included within a specified range (e.g., a range between about 133 degrees and about 137 degrees from the (+x)-axis direction), and the representative moving direction corresponds to the specified direction (e.g., the F/B direction opposite to the moving direction of the host vehicle). Further, the processor of the object recognition apparatus may identify, as the representative point, the center point between the vertex with an index of 0 after the change and the vertex with an index of 3 after the change, rather than the center point between the vertex with an index of 3 before the change (e.g., the vertex with an index of 2 after the change) and the vertex with an index of 0 before the change (e.g., the vertex with an index of 3 after the change).

According to an embodiment, in the third situation 707, the heading of the object box of the object may be included in a range of a value obtained by adding or subtracting a specified value to or from about +45 degrees in the (+x)-axis direction (e.g., more than or equal to about 43 degrees and less than about 47 degrees).

The processor of the object recognition apparatus may re-identify the index corresponding to the object box when the track heading of the object box is included within a specified range (e.g., a range between about 43 degrees and about 47 degrees from the (+x)-axis direction), and the representative moving direction corresponds to the specified direction (e.g., the RR direction that is right to the moving direction of the host vehicle). Further, the processor of the object recognition apparatus may identify, as the representative point, the center point between the vertex with an index of 2 after the change and the vertex with an index of 3 after the change, rather than the center point between the vertex with an index of 2 before the change (e.g., the vertex with an index of 1 after the change) and the vertex with an index of 3 before the change (e.g., the vertex with an index of 2 after the change).

According to an embodiment, in the fourth situation 709, the heading of the object box of the object may be included in a range of a value obtained by adding or subtracting a specified value to or from about +45 degrees in the (+x)-axis direction (e.g., more than or equal to about 43 degrees and less than about 47 degrees).

The processor of the object recognition apparatus may re-identify the index corresponding to the object box when the track heading of the object box is included within a specified range (e.g., a range between about −133 degrees and about −137 degrees from the (+x)-axis direction), and the representative moving direction corresponds to the specified direction (e.g., the LL direction that is left to the moving direction of the host vehicle). Further, the processor of the object recognition apparatus may identify, as the representative point, the center point between the vertex with an index of 1 after the change and the vertex with an index of 0 after the change, rather than the center point between the vertex with an index of 1 before the change (e.g., the vertex with an index of 0 after the change) and the vertex with an index of 0 before the change (e.g., the vertex with an index of 3 after the change).

FIG. 8 shows an example of a representative point identified based on a heading, a track heading, and a representative moving direction in an object recognition apparatus or an object recognition method according to an embodiment of the present disclosure.

Referring to FIG. 8, the heading of the object box of an object 801 may be included within a second reference range. A first situation 803, a second situation 805, a third situation 807, and a fourth situation 809 may represent an object whose track heading is included within a specified range and whose moving direction is a specified direction.

According to an embodiment, the heading of the object box of the object 801 may be included in the range of a value obtained by adding or subtracting a specified value to or from about −45 degrees in the (+x)-axis direction. For example, the heading of the object box of the object 801 may be included in a range of more than or equal to about −43 degrees and less than about −47 degrees in the (+x)-axis direction, but embodiments of the present disclosure may not be limited thereto.

According to an embodiment, when the representative moving direction of the object 801 is an F/B direction opposite to the moving direction of the host vehicle, the representative point may correspond to the center point of a line segment formed by the vertex of an object box assigned an index of 0 and the vertex of an object box assigned an index of 3.

According to an embodiment, when the heading of the object is included in a second reference range, the processor of the object recognition apparatus may identify a representative point differently from the representative point identified according to a representative moving direction and an index in four situations. The four situations may include the first situation 803, the second situation 805, the third situation 807, and the fourth situation 809.

According to an embodiment, the processor of the object recognition apparatus may identify the track heading of an object box in a first frame based on the heading of the first frame and the heading of the object box in at least one frame before the first frame. For example, when the heading of the object box was about −45 degrees from the (+x)-axis direction in two or more frames before the first frame, the track heading of the object box may be about −45 degrees.

According to an embodiment, in the first situation 803, the heading of the object box of the object may be included in a range of a value obtained by adding or subtracting a specified value to or from about −45 degrees in the (+x)-axis direction (e.g., more than or equal to about −43 degrees and less than about −47 degrees).

The processor of the object recognition apparatus may re-identify the index corresponding to the object box when the track heading of the object box is included within a specified range (e.g., a range between about 43 degrees and about 47 degrees from the (+x)-axis direction), and the representative moving direction corresponds to the specified direction (e.g., the F/F direction identical to the moving direction of the host vehicle). Further, the processor of the object recognition apparatus may identify, as the representative point, the center point between the vertex with an index of 0 after the change and the vertex with an index of 3 after the change, rather than the center point between the vertex with an index of 3 before the change (e.g., the vertex with an index of 0 after the change) and the vertex with an index of 0 before the change (e.g., the vertex with an index of 1 after the change).

According to an embodiment, in the second situation 805, the heading of the object box of the object may be included in a range of a value obtained by adding or subtracting a specified value to or from about −45 degrees in the (+x)-axis direction (e.g., more than or equal to about −43 degrees and less than about −47 degrees).

The processor of the object recognition apparatus may re-identify the index corresponding to the object box when the track heading of the object box is included within a specified range (e.g., a range between about −133 degrees and about −137 degrees from the (+x)-axis direction), and the representative moving direction corresponds to the specified direction (e.g., the F/B direction opposite to the moving direction of the host vehicle). Further, the processor of the object recognition apparatus may identify, as the representative point, the center point between the vertex with an index of 0 after the change and the vertex with an index of 3 after the change, rather than the center point between the vertex with an index of 0 before the change (e.g., the vertex with an index of 1 after the change) and the vertex with an index of 3 before the change (e.g., the vertex with an index of 0 after the change).

According to an embodiment, in the third situation 807, the heading of the object box of the object may be included in a range of a value obtained by adding or subtracting a specified value to or from about −45 degrees in the (+x)-axis direction (e.g., more than or equal to about −43 degrees and less than about −47 degrees).

The processor of the object recognition apparatus may re-identify the index corresponding to the object box when the track heading of the object box is included within a specified range (e.g., a range between about −43 degrees and about −47 degrees from the (+x)-axis direction), and the representative moving direction corresponds to the specified direction (e.g., the RR direction that is right to the moving direction of the host vehicle). Further, the processor of the object recognition apparatus may identify, as the representative point, the center point between the vertex with an index of 2 after the change and the vertex with an index of 3 after the change, rather than the center point between the vertex with an index of 3 before the change (e.g., the vertex with an index of 0 after the change) and the vertex with an index of 2 before the change (e.g., the vertex with an index of 3 after the change).

According to an embodiment, in the fourth situation 809, the heading of the object box of the object may be included in a range of a value obtained by adding or subtracting a specified value to or from about −45 degrees in the (+x)-axis direction (e.g., more than or equal to about −43 degrees and less than about −47 degrees).

The processor of the object recognition apparatus may re-identify the index corresponding to the object box when the track heading of the object box is included within a specified range (e.g., a range between about 133 degrees and about 137 degrees from the (+x)-axis direction), and the representative moving direction corresponds to the specified direction (e.g., the LL direction that is left to the moving direction of the host vehicle). Further, the processor of the object recognition apparatus may identify, as the representative point, the center point between the vertex with an index of 0 after the change and the vertex with an index of 1 after the change, rather than the center point between the vertex with an index of 0 before the change (e.g., the vertex with an index of 1 after the change) and the vertex with an index of 1 before the change (e.g., the vertex with an index of 2 after the change).

FIG. 9 shows an example of a representative point identified according to a representative moving direction in an object recognition apparatus or an object recognition method according to an embodiment of the present disclosure.

Referring to FIG. 9, in a screen 901, a first object 903 may span (e.g., intersect) the y-axis. A second object 905 may have a representative moving direction opposite to the moving direction of a host vehicle. A third object 907 may have a representative moving direction to the left from (e.g., rotated 90 degrees counterclockwise relative to) the moving direction of the host vehicle. A fourth object 909 may have a representative moving direction to the right from (e.g., rotated 90 degrees clockwise relative to) the moving direction of the host vehicle. A fifth object 911 may have a representative moving direction that is the same as the moving direction of the host vehicle. According to an embodiment, the same direction as the moving direction of the host vehicle may be referred to as a direction away from the host vehicle in the longitudinal direction (also referred to as a forward-facing longitudinal direction). The second object 905 and the fifth object 911 may each have a representative moving direction that is parallel to the longitudinal axis of the host vehicle (e.g., the X-axis as shown in FIG. 9). The third object 907 and the fourth object 909 may each have a representative moving direction that is perpendicular to the longitudinal axis of the host vehicle or parallel to the lateral axis of the host vehicle (e.g., the Y-axis as shown in FIG. 9).

According to an embodiment, the processor of the object recognition apparatus may identify the representative point of the first object 903 based on one line segment that precedes in the direction away from the host vehicle in the longitudinal direction and is one of the line segments constituting an object box. In other words, the representative point of the first object 903 may be identified based on the line segment preceding in the moving direction of the host vehicle. The representative point of the first object 903 may be located between a vertex assigned an index of 1 and a vertex assigned an index of 2.

According to an embodiment, the processor of the object recognition apparatus may identify the representative point of the second object 905 based on one line segment that precedes in the direction close to the host vehicle in the longitudinal direction and is one of the line segments constituting an object box. In other words, the representative point of the second object 905 may be identified based on the line segment preceding in the direction opposite to the moving direction of the host vehicle (also referred to as a backward-facing longitudinal direction). The line segment may, among the line segments constituting the object box, have the smallest longitudinal distance to the host vehicle (e.g., closest to the lateral axis of the host vehicle, such as the Y-axis as shown in FIG. 9). The representative point of the second object 905 may be located between a vertex assigned an index of 0 and a vertex assigned an index of 3.

According to an embodiment, the processor of the object recognition apparatus may identify the representative point of the third object 907 based on one line segment that precedes in the left direction with respect to the moving direction of the host vehicle and is one of the line segments constituting an object box. The line segment may, among the line segments constituting the object box, have the smallest lateral distance to the host vehicle (e.g., closest to the longitudinal axis of the host vehicle, such as the X-axis as shown in FIG. 9). The representative point of the third object 907 may be located between a vertex assigned an index of 1 and a vertex assigned an index of 0.

According to an embodiment, the processor of the object recognition apparatus may identify the representative point of the fourth object 909 based on one line segment that precedes in the right direction with respect to the moving direction of the host vehicle and is one of the line segments constituting the object box. The line segment may, among the line segments constituting the object box, have the smallest lateral distance to the host vehicle (e.g., closest to the longitudinal axis of the host vehicle, such as the X-axis as shown in FIG. 9). The representative point of the fourth object 909 may be located between the vertex assigned an index of 2 and the vertex assigned an index of 3.

According to an embodiment, the processor of the object recognition apparatus may identify the representative point of the fifth object 911 based on a line segment that follows in the direction away from the host vehicle in the longitudinal direction and is one of the line segments that constitute the object box. In other words, the representative point of the fifth object 911 may be identified based on the line segment following in the direction opposite to the moving direction of the host vehicle. The line segment may, among the line segments constituting the object box, have the smallest longitudinal distance to the host vehicle (e.g., closest to the lateral axis of the host vehicle, such as the Y-axis as shown in FIG. 9). The representative point of the fifth object 911 may be located between a vertex assigned an index of 0 and a vertex assigned an index of 3.

The processor of the object recognition apparatus may identify a representative point representing an object (e.g., first object 903, second object 905, third object 907, fourth object 909, or fifth object 911) based on a center point of one of the line segments constituting the object box or any other point of the one line segment.

According to one embodiment, the processor of the object recognition apparatus may assign a specified value (e.g., 0) to the vertex in one direction (e.g., left direction) of the line segment that is closest to the y-axis and has a small angle with the y-axis among the line segments constituting the object box. The processor of the object recognition apparatus may sequentially assign indices in the direction of rotation (e.g., clockwise), starting from the vertex indexed with a specified value (e.g., 0).

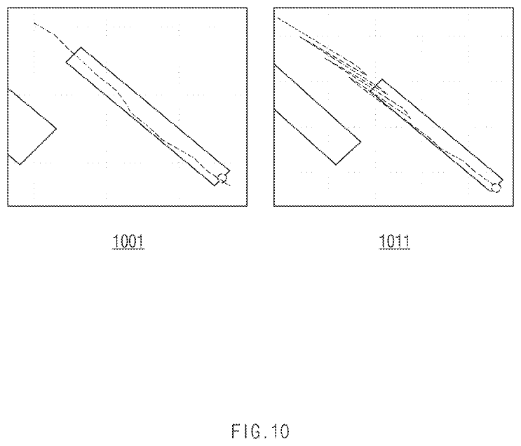

FIG. 10 shows examples of representative points provided according to an existing object recognition apparatus or an object recognition method and an example of representative points provided according to an object recognition apparatus or an object recognition method according to an embodiment of the present disclosure.

Referring to FIG. 10, a first path 1001 may represent a path of representative points over time, which are identified by an object recognition apparatus according to an embodiment. A second path 1011 may represent a path of representative points over time which are identified by an existing object recognition apparatus.

According to an embodiment, the processor of the object recognition apparatus may identify the representative points of an object based on the moving direction of the object and the indexes assigned to the vertices of the object box.

In the first path 1001, the processor of the object recognition apparatus may identify a representative moving direction based on the reliability of the moving direction and, because the indices assigned to the vertices of the object box are also changed when a specified condition is met, representative points different from the representative points in the second path 1011 may be identified.

Unlike the representative points in the second path 1011, representative points in the first path 1001 may be identified continuously.

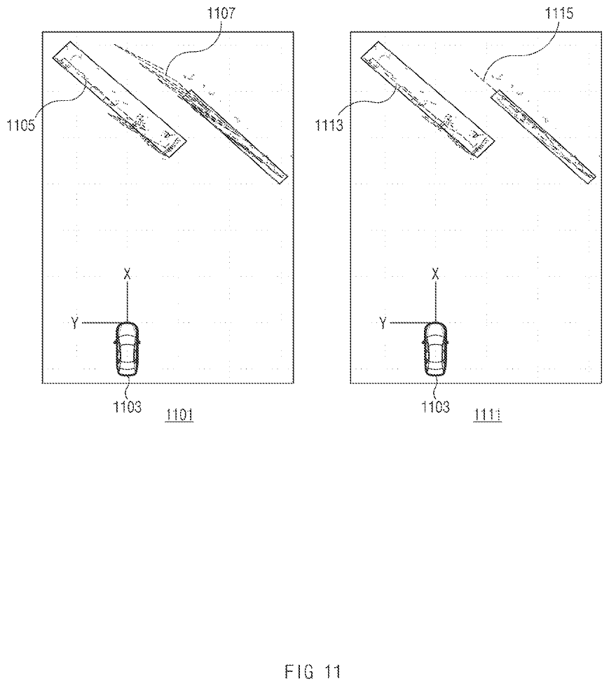

FIG. 11 shows an example of a path of an object, which is identified based on an existing object recognition apparatus or an object recognition method and a path of an object, which is identified based on an object recognition apparatus or an object recognition method according to an embodiment of the present disclosure.

Referring to FIG. 11, a first screen 1101 may display a path of representative points over time, which are identified by an existing object recognition apparatus. The first screen 1101 may include a first path 1105, which is a path of representative points identified for the first object, and a second path 1107, which is a path of representative points identified for the second object. The first path 1105 and the second path 1107 may be identified by the object recognition apparatus of a host vehicle 1103.

The second screen 1111 may display a path of representative points over time which are identified by the object recognition apparatus according to an embodiment. The second screen 1111 may include a third path 1113, which is a path of representative points identified for the first object, and a fourth path 1115, which is a path of representative points identified for the second object. The third path 1113 and the fourth path 1115 may be identified by the object recognition apparatus of the host vehicle 1103.

In the third path 1113, the processor of the object recognition apparatus may identify a representative moving direction based on the reliability of the moving direction and, because the indices assigned to the vertices of the object box are also changed when a specified condition is met, representative points different from the representative points in the first path 1015 may be identified.

In the fourth path 1115, the processor of the object recognition apparatus may identify a representative moving direction based on the reliability of the moving direction and, because the indices assigned to the vertices of the object box are also changed when a specified condition is met, representative points different from the representative points in the second path 1107 may be identified.

The representative points in the third path 1113 and the representative points in the fourth path 1115 are identified sequentially unlike the representative points in the first path 1105 and the representative points in the second path 1107.

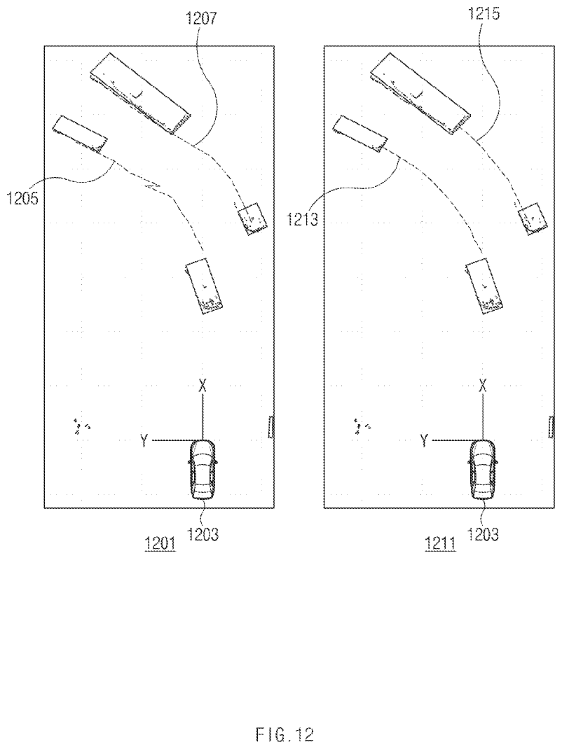

FIG. 12 shows an example of a path of an object identified based on an existing object recognition apparatus or an object recognition method and an example of a path of an object identified based on an object recognition apparatus or an object recognition method according to an embodiment of the present disclosure.

Referring to FIG. 12, a first screen 1201 may display a path of representative points over time which are identified by an existing object recognition apparatus. The first screen 1201 may include a first path 1205, which is a path of representative points identified for the first object, and a second path 1207, which is a path of representative points identified for the second object. The first path 1205 and the second path 1207 may be identified by the object recognition apparatus of a host vehicle 1203.

The second screen 1211 may display a path of representative points over time which are identified by the object recognition apparatus according to an embodiment. The second screen 1211 may include a third path 1213, which is a path of representative points identified for the first object, and a fourth path 1215, which is a path of representative points identified for the second object. The third path 1213 and the fourth path 1215 may be identified by the object recognition apparatus of the host vehicle 1203.

In the third path 1213, the processor of the object recognition apparatus may identify a representative moving direction based on the reliability of the moving direction and, because the indices assigned to the vertices of the object box are also changed when a specified condition is met, representative points different from the representative points in the first path 1205 may be identified.

In the fourth path 1215, the processor of the object recognition apparatus may identify a representative moving direction based on the reliability of the moving direction and, because the indices assigned to the vertices of the object box are also changed when a specified condition is met, representative points different from the representative points in the second path 1207 may be identified.

The representative points in the third path 1213 and the representative points in the fourth path 1215 are identified sequentially unlike the representative points in the first path 1205 and the representative points in the second path 1207.

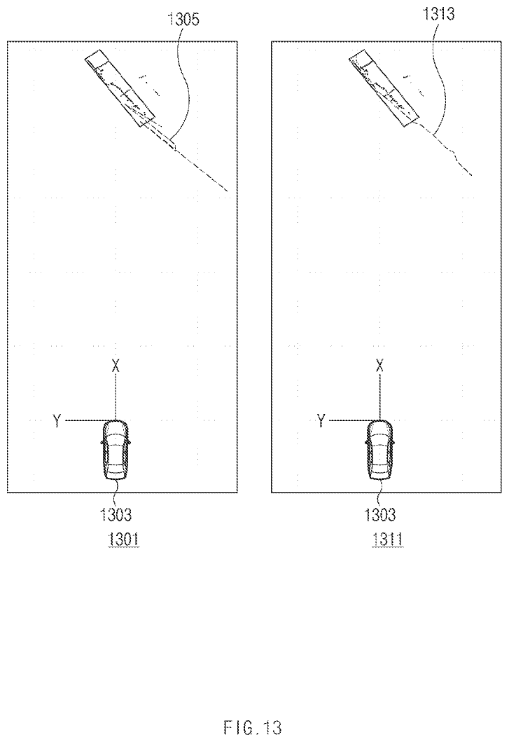

FIG. 13 shows an example of a path of an object, which is identified based on an existing object recognition apparatus or an object recognition method and a path of an object, which is identified based on an object recognition apparatus or an object recognition method according to an embodiment of the present disclosure.

Referring to FIG. 13, a first screen 1301 may display a path of representative points over time, which are identified by an existing object recognition apparatus. The first screen 1301 may include a first path 1305, which is a path of representative points identified for the first object. The first path 1305 may be identified by the object recognition apparatus of a host vehicle 1303.

A second screen 1311 may display a path of representative points over time which are identified by the object recognition apparatus according to an embodiment. The second screen 1311 may include a second path 1313, which is a path of representative points identified for the first object. The second path 1313 may be identified by the object recognition apparatus of the host vehicle 1303.

In the second path 1313, the processor of the object recognition apparatus may identify a representative moving direction based on the reliability of the moving direction and, because the indices assigned to the vertices of the object box are also changed when a specified condition is met, representative points different from the representative points in the first path 1305 may be identified.

Unlike the representative points in the first path 1305, representative points in the second path 1313 may be identified continuously.

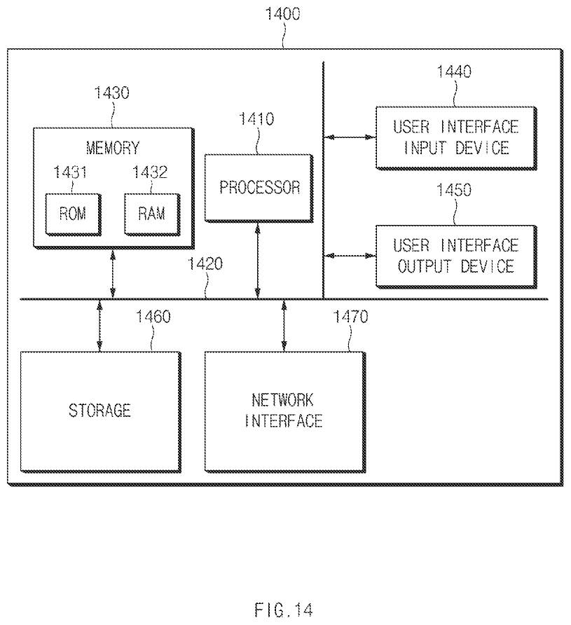

FIG. 14 shows a computing system related to an object recognition apparatus and an object recognition method according to an embodiment of the present disclosure.

Referring to FIG. 14, a computing system 1400 may include at least one processor 1410, a memory 1430, a user interface input device 1440, a user interface output device 1450, storage 1460, and a network interface 1470, which are connected with each other via a bus 1420.

The processor 1410 may be a central processing unit (CPU) or a semiconductor device that processes instructions stored in the memory 1430 and/or the storage 1460. The memory 1430 and the storage 1460 may include various types of volatile or non-volatile storage media. For example, the memory 1430 may include a ROM (Read Only Memory) 1431 and a RAM (Random Access Memory) 1432.

Thus, the operations of the method or the algorithm described in connection with the embodiments disclosed herein may be embodied directly in hardware or a software module executed by the processor 1410, or in a combination thereof. The software module may reside on a storage medium (that is, the memory 1430 and/or the storage 1460) such as a RAM, a flash memory, a ROM, an EPROM, an EEPROM, a register, a hard disk, a removable disk, and a CD-ROM.

The exemplary storage medium may be coupled to the processor 1410, and the processor 1410 may read information out of the storage medium and may record information in the storage medium. Alternatively, the storage medium may be integrated with the processor 1410. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may increase the accuracy of determination of identifying whether an object is a moving object or a movable stationary object by using the moving direction of an object greater than a specific reliability value.

The present technology may identify whether an object is a moving object or a movable stationary object by tracking a representative point that is a specific point representing an object.

Further, the present technology may enhance user experience by improving the accuracy of determination of identifying whether an object is a moving object or a movable stationary object.

Further, the present technology may improve the performance of autonomous driving or driver assistance driving by improving the accuracy of determination of identifying whether an object is a moving object or a movable stationary object.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An object recognition apparatus comprising:
a sensor associated with a vehicle; and
a processor configured to:
determine, via the sensor, an object in a first frame;
determine a first moving direction of the object in the first frame;
determine a reliability value of the first moving direction;
determine a point representing the object in the first frame based on a representative moving direction of the object, wherein the representative moving direction is one of:
the first moving direction based on the reliability value being greater than a threshold value, or
a second moving direction of the object in a second frame preceding the first frame based on the reliability value being less than or equal to the threshold value; and
output, based on a first position of the point in the first frame and a second position of the point in at least one frame before the first frame, a signal indicating whether the object is a moving object or a movable stationary object.

2. The object recognition apparatus of claim 1, wherein the processor is configured to determine the point by:
determining an object box representing the object in the first frame;
determining, based on the representative moving direction, a line segment associated with the object box; and
determining the point further based on the line segment.

3. The object recognition apparatus of claim 1, wherein the processor is configured to determine the point by:
determining an object box representing the object in the first frame;
determining, based on a third position of the object in the first frame and a fourth position of the object in the at least one frame before the first frame, a first heading of the object box in the first frame;
determining, based on the first heading and a second heading of the object box in the at least one frame before the first frame, a track heading of the object box in the first frame;
determining a line segment associated with the object box based on the first heading being within a first range, the track heading being within a second range, and the representative moving direction being a specified direction; and
determining the point further based on the line segment.

4. The object recognition apparatus of claim 1, wherein the processor is configured to determine the point by:
determining an object box representing the object in the first frame;
assigning a different index, of a plurality of indices, to each of a plurality of vertices forming the object box; and
determining the point, further based on the plurality of indices.

5. The object recognition apparatus of claim 1, wherein the processor is configured to determine the point by:
determining an object box representing the object in the first frame;
determining, based on the first position of the object in the first frame, and the second position of the object in the at least one frame before the first frame, a first heading of the object box;
determining, based on the first heading and a second heading of the object box in the at least one frame before the first frame, a track heading of the object box in the first frame;
assigning a different index, of a plurality of indices, to each of a plurality of vertices forming the object box, based on the first heading being within a first range, the track heading being within a second range, and the representative moving direction being a specified direction; and
determining the point further based on the plurality of indices.

6. The object recognition apparatus of claim 1, wherein the processor is configured to determine the point by:
determining an object box representing the object in the first frame; and
determining the point based on one of:
a first line segment having, among line segments associated with the object box, a smallest longitudinal distance to the vehicle, based on the representative moving direction being parallel to a longitudinal axis of the vehicle, or
a second line segment having, among the line segments associated with the object box, a smallest lateral distance to the vehicle, based on the representative moving direction being perpendicular to the longitudinal axis of the vehicle.

7. The object recognition apparatus of claim 1, wherein the processor is configured to determine the point by:
determining an object box representing the object in the first frame; and
determining the point based on a center point of one line segment among line segments constituting the object box.

8. The object recognition apparatus of claim 1, wherein the processor is configured to determine the first moving direction of the object in the first frame based on a value obtained by adding a first distance moved by the vehicle to a second distance moved by the object with respect to the vehicle, wherein the second distance is determined based on a difference between the first position and the second position.

9. The object recognition apparatus of claim 1, wherein the processor is configured to determine whether the object is a moving object or a movable stationary object further based on a speed of the object, wherein the speed of the object is determined based on the first position and the second position.

10. The object recognition apparatus of claim 1, wherein the processor is further configured to assign, to the object, one of:
a first identifier indicating that the object is a moving object, or
a second identifier indicating that the object is a movable stationary object.

11. An object recognition method performed by a processor, the method comprising:
determining, via a sensor associated with a vehicle, an object in a first frame;
determining a first moving direction of the object in the first frame;
determining a reliability value of the first moving direction;
determining a point representing the object in the first frame based on a representative moving direction of the object, wherein the representative moving direction is one of:
the first moving direction based on the reliability value being greater than a threshold value, or
a second moving direction of the object in a second frame preceding the first frame based on the reliability value being less than or equal to the threshold value; and
outputting, based on a first position of the point in the first frame and a second position of the point in at least one frame before the first frame, a signal indicating whether the object is a moving object or a movable stationary object.

12. The object recognition method of claim 11, wherein the determining of the point comprises:
determining an object box representing the object in the first frame;
determining, based on the representative moving direction, a line segment associated with the object box; and
determining the point further based on the line segment.

13. The object recognition method of claim 11, wherein the determining of the point comprises:
determining an object box representing the object in the first frame;
determining, based on a third position of the object in the first frame and a fourth position of the object in the at least one frame before the first frame, a first heading of the object box in the first frame;
determining, based on the first heading and a second heading of the object box in the at least one frame before the first frame, a track heading of the object box in the first frame;
determining a line segment associated with the object box based on the first heading being within a first range, the track heading being within a second range, and the representative moving direction being a specified direction; and
determining the point further based on the line segment.

14. The object recognition method of claim 11, wherein the determining of the point comprises:
determining an object box representing the object in the first frame;
assigning a different index, of a plurality of indices, to each of a plurality of vertices forming the object box; and
determining the point, further based on the plurality of indices.

15. The object recognition method of claim 11, wherein the determining of the point comprises:
determining an object box representing the object in the first frame;
determining, based on the first position of the object in the first frame, and the second position of the object in the at least one frame before the first frame, a first heading of the object box;
determining, based on the first heading and a second heading of the object box in the at least one frame before the first frame, a track heading of the object box in the first frame;
assigning a different index, of a plurality of indices, to each of a plurality of vertices forming the object box, based on the first heading being within a first range, the track heading being within a second range, and the representative moving direction being a specified direction; and
determining the point further based on the plurality of indices.

16. The object recognition method of claim 11, wherein the determining of the point comprises:
determining an object box representing the object in the first frame; and
determining the point based on one of:
a first line segment having, among line segments associated with the object box, a smallest longitudinal distance to the vehicle, based on the representative moving direction being parallel to a longitudinal axis of the vehicle, or
a second line segment having, among the line segments associated with the object box, a smallest lateral distance to the vehicle, based on the representative moving direction being perpendicular to the longitudinal axis of the vehicle.

17. The object recognition method of claim 11, wherein the determining of the point comprises:
determining an object box representing the object in the first frame; and
determining the point based on a center point of one line segment among line segments constituting the object box.

18. The object recognition method of claim 11, wherein the determining of the first moving direction of the object in the first frame comprises determining the first moving direction of the object in the first frame based on a value obtained by adding a first distance moved by the vehicle to a second distance moved by the object with respect to the vehicle, wherein the second distance is determined based on a difference between the first position and the second position.

19. The object recognition method of claim 11, further comprising:
determining whether the object is a moving object or a movable stationary object further based on a speed of the object, wherein the speed of the object is determined based on the first position and the second position.

20. The object recognition method of claim 11, further comprising:
assigning, to the object, one of:
a first identifier indicating that the object is a moving object, or
a second identifier indicating that the object is a movable stationary object.
